(19) United States
(12) Patent Application Publication
(10) Pub. No.: US 2009/0037881 A1
(43) Pub. Date: Feb. 5, 2009

(54) SYSTEMS AND METHODS FOR TESTING THE FUNCTIONALITY OF A WEB-BASED APPLICATION

(75) Inventors: Alex H. Christy, Peoria, IL (US); Jeffrey W. Badorek, Bartonville, IL (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: Caterpillar Inc., Peoria, IL (US)

(21) Appl. No.: 11/831,486

(22) Filed: Jul. 31, 2007

(51) Int. Cl. G06F 11/36

(52) U.S. Cl. 717/124

(57) ABSTRACT

A web-based application testing method and system provides a graphical user interface via a web page with user-selectable options of performable testing steps organized in a logical testing hierarchy. Options selected by users are converted into a text-based test script. The text-based test script is executed in a specified environment for the web-based application.

### TECHNICAL FIELD

The present disclosure relates generally to systems and methods for testing computer software applications, and more particularly, to systems and methods for testing the functionality of web applications using web-based tools.

### BACKGROUND

Web applications have grown over the last several years. Web applications are popular due to the ubiquity of a client, sometimes called a thin client. Web applications dynamically generate a series of Web documents in a standard format supported by common browsers. Client-side scripting in a standard language such as JavaScript is commonly included to add dynamic elements to the user interface. Generally, each individual Web page is delivered to the client as a static document, but the sequence of pages can provide an interactive experience, as user input is returned through Web form elements embedded in the page markup. During the session, the Web browser interprets and displays the pages, and acts as the universal client for any Web application. The ability to update and maintain Web applications without distributing and installing software on potentially thousands of client computers is a key reason for their popularity. It is desirable to provide adequate testing procedures and environments in which Web-based applications are intended to operate.

Existing testing systems, such as HP's WINRUNNER software, require either the use of a programming language, such as C, or recording test sequences through macros. The resulting test files thus lack portability across diverse enterprise systems, and/or require technical knowledge of computer programming language.

### BRIEF SUMMARY

This disclosure describes, in one aspect, a method of testing the functionality of a web-based application. The method provides a graphical user interface via a web page that contains hierarchically-based user-selectable options of performable testing steps. The method receives, via the web page, selected options from the graphical user interface. The received options are converted into a text-based test script. The method thereafter executes the text-based test script in a specified environment for the web-based application.

In another aspect, this disclosure describes a system for testing the functionality of a web-based application. The system includes a graphical user interface for specifying instances of conditions to be tested in a simulated execution of the web-based application. A text-based test script generated from the entries in the graphical user interface is connected to the graphical user interface. The system also includes a user-selectable environment selection option for specifying one of a plurality of environments for which a simulated execution is to occur. A pre-simulation engine is also provided for automatically conforming the text-based script to criteria for a specified environment. Finally, the system includes a simulation engine for simulating execution of the text-based test script on a specified environment.

### BRIEF DESCRIPTION OF THE DRAWINGS

FIG. 1 is a block diagram representation of a system for testing software according to the disclosure.

FIG. 2 is a flow chart illustrating the steps carried out by the system shown in FIG. 1.

FIG. 3 is an exemplary screen display illustrating a user interface according to the disclosure.

FIG. 4 is a further screen display illustrating the user interface according to the disclosure.

FIG. 5 is an exemplary screen display illustrating user selection of certain test verification procedures according to the disclosure.

FIG. 6 is an exemplary screen display illustrating test code generated according to the disclosure.

FIG. 7 is an exemplary screen display illustrating further test code according to the disclosure.

FIG. 8 is a further screen display illustrating test code execution by the system according to the disclosure.

FIG. 9 is an exemplary screen display illustrating test failure of a web-based application according to the disclosure.

FIG. 10 is a further screen display illustrating a test failure according to the disclosure.

### DETAILED DESCRIPTION

This disclosure relates to a system and method for testing the functionality of web-based applications, such as those created or developed within an organization. The system presents an interactive graphical user interface that enables users to test their Web-based application software in a logical and uniform fashion across organization groups. Specifically, the graphical user interface presents a web page with a plurality of user-selectable testing options arranged in a hierarchical format. Based on the receipt of options as selected by a user, the system creates a text-based test script, which is thereafter translated and executed in a specified environment for the web-based application.

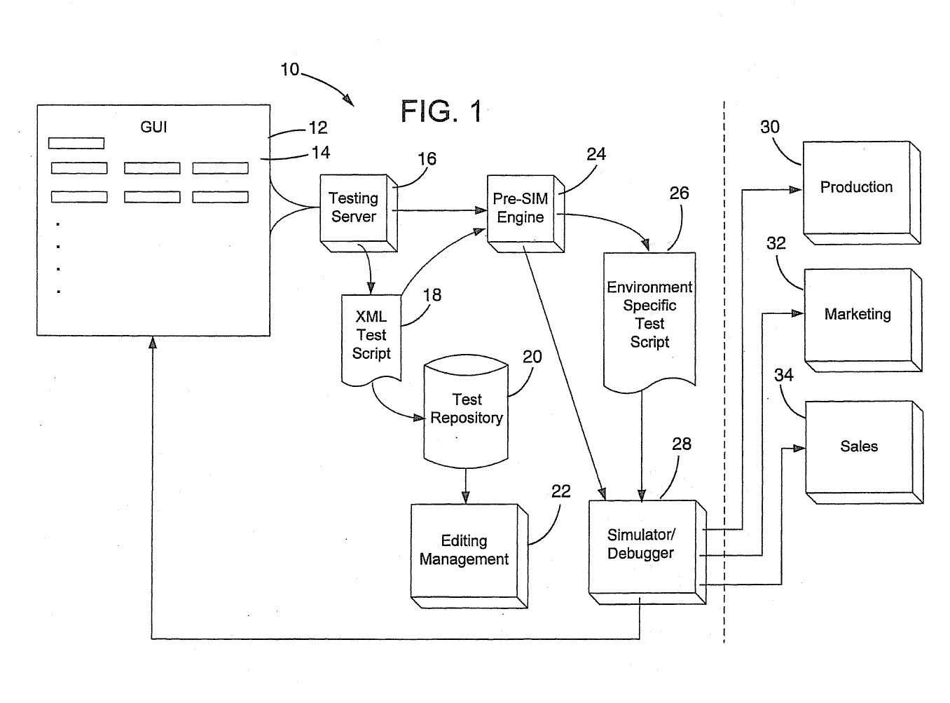

FIG. 1 illustrates a testing system 10 and environment for testing the functionality of a Web-based application. In the illustrated embodiment, the Web-based application is created by personnel within a certain group in an organization. The testing system 10 is disposed to present an interactive graphical user interface (GUI) 12 to a user. That is, the GUI 12 is presented on a user's computer (not shown) within the organization. By way of example, the user may have developed a Web-based application specific to the user's particular group or to a particular task.

As explained in further detail below, the testing system 10 uses the GUI 12 for both creating Web-application tests for simulation and for running/debugging tests that are created.

Test creation is described more fully hereinafter, but preferably includes a hierarchical selection interface, denoted by the numeral 14 in FIG. 1. The hierarchical selection interface 14 presents a logical menu of selectable items that users, even without a great degree of testing experience, can readily and intuitively utilize. This enables testing parameters and conditions to be generated “on the fly,” without specialized understanding of the underlying software or the environment in which it will be executing.

The GUI 12 is preferably itself a web-based application. Users can log in to the application presented by the GUI 12 and receive customized testing parameters based on policies and permissions that are implemented to limit access of users or user classes to certain test functions. Access/permissions can be controlled by an administrator, as described in greater detail below.

As shown in FIG. 1, the GUI 12 is presented by and communicates with a testing server 16. The testing server 16 operates to cause graphically created test procedures, as generated through interaction by a user with the hierarchical interface, to convert into one or more text-based test scripts 18. That is, the testing server 18 converts responses by users to various menu-based items into one or more short programs that are used to test at least a portion of the Web-based application functionality. The testing server 16 generates the text-based scripts 18 according to a high-level markup language such as XML. Thus, the text-based scripts 18 provide a ready way in which to analyze the test script, or to save the test script for later use. As explained below, the test scripts 18 are easily converted to environment-specific test scripts suitable for a particular environment in which the script will be operated. In this way, the generated text-based scripts can be modified and/or re-used by entities within an organization.

The text-based test script 18 is stored in a repository of test scripts 20. This permits the text-based script 18 to be accessed at a future time and by testers of similar or different web-based applications. Additionally, administrators can access the test scripts in the repository 20 through standard editing and file management tools 22. In this way, an administrator can search across the entire text repository 20 to find test scripts that are relevant to a current test objective. In addition, the administrator can perform global find-and-replace operations or the like among the text-based test scripts 18 stored in the repository 20 if necessary or desirable. This provides an advantage with respect to testing environments in which testers or system administrators can perform test updates by either through manual searching and editing techniques or by writing new test scripts to perform such updates.

In a preferred embodiment, the testing server 16 operates to cause the GUI 12 to present a given test in multiple display modes. FIG. 1 illustrates one such display mode as a hierarchical menu selection display mode. In another display mode, the GUI 12 presents the text-based test script 18 to enable the user to view and/or modify the test script. Finally, the GUI 12 includes a further display mode for presenting a sequence of environment-specific testing steps created from the text-based test script. Accordingly, through the GUI 12, the user can also run and debug a test. The GUI 12 contains selections for multiple environments in which to test the application functionality. These environments may include, by way of example, Quality Assurance, software development, and software testing environment, among others.

The testing server 16 uses a pre-simulation software engine 24 to convert the text-based test script into actual steps to be performed in the specified environment. The steps can be presented in an environment-specific test script, as denoted by a numeral 26 in FIG. 1, for display on the GUI 12. The conversion is preferably performed according to administered rules for the system. Such rules may include substituting appropriate variable values according to the selected environment.

A simulator/debugger software module 28 executes the environment-specific steps according to the environment-specific test script 26 in a controlled environment in a manner consistent with existing debugging systems. Specifically, the simulator/debugger software module 28 communicates with the pre-simulation software engine 24 to receive the environment-specific test script 26, as generated by the pre-simulation software engine 24. The output from the simulator/debugger module 28 is also displayed through the GUI 12, preferably in any of several ways to be discussed below. Once the debugging process has completed, the environment-specific test script may be executed in an appropriate environment within an organization. In the example shown in FIG. 1, such other particular environments may include a production department 30, marketing 32 and sales environment 34. The disclosure, however, is intended to operate within any particular environment in an organization.

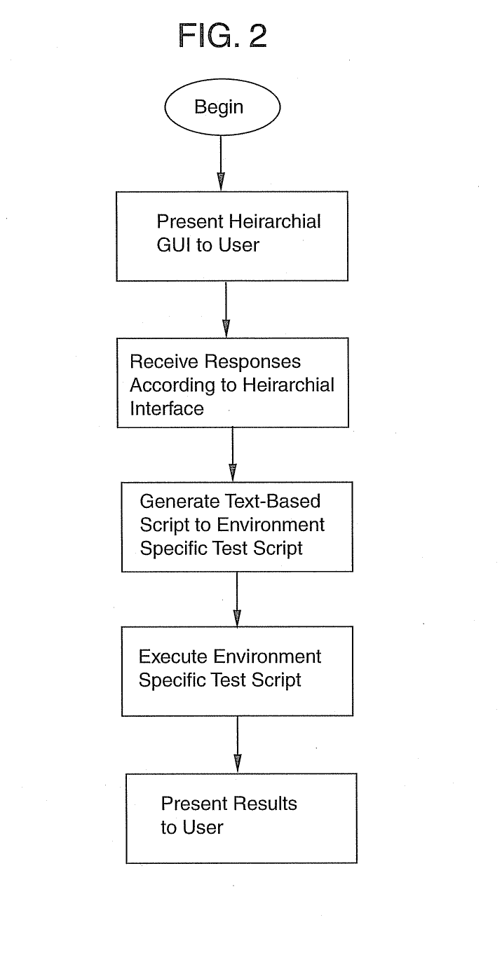

FIG. 2 illustrates a flow chart for implementing the testing system 10 shown in FIG. 1. The testing server 16 begins and presents the GUI 12 on the user's display. The testing server 16 thereafter receives requests for content by one or more users. The testing server 16 operates in a logical fashion to provide responses that are displayed, via the user's Web browser, on the display. Specifically, the testing server 16 provides a GUI with a user-selectable hierarchal interface 14 of test parameters and conditions.

Upon the receipt of selected test parameters, the testing server 16 operates to generate text-based test scripts, such as XML-based test script 18. The testing server 16 stores the test script 18 in the test repository 20. In addition, the test server 16 provides the XML-based test script to the pre-simulation engine 24.

The pre-simulation engine 24 converts the XML-based test script into an environment-specific test script 26. Such conversion includes replacement of variables, insertion of environment-specific methods and parameters, and the like. Thereafter, the simulator/debugger software module 28 executes the environment-specific test script 26, and enables the user to modify the Web-based application by presenting the results to the user via the GUI 12.

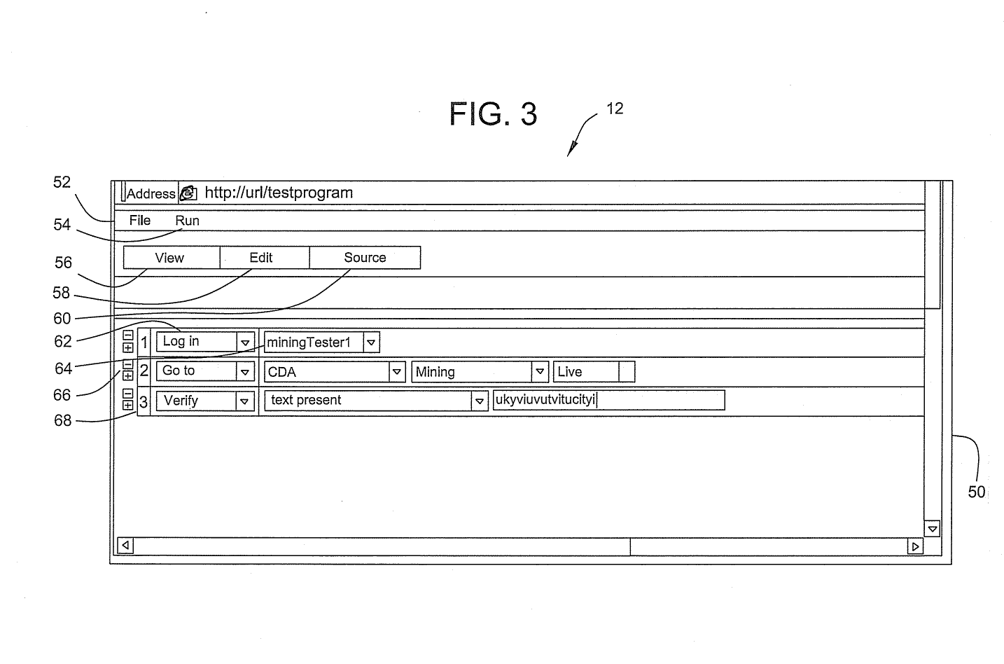

FIG. 3 illustrates an exemplary testing GUI 12 in greater detail. The screen of FIG. 3 is presented to the user via a standard web browser, such as MICROSOFT INTERNET EXPLORER. The GUI 12 allows a user to create, edit and run scripts to test the functionality of web-based applications. Within a browser window 50, a “File” drop-down menu 52 is presented to allow the user to perform file maintenance functions with respect to test scripts. These include such functions as creating, opening, saving, and/or reverting to prior, test scripts. A “Run” menu 54 is also presented to allow the user to select a running environment (e.g., development) and initiate the execution of a test script in that environment.

Three options are further presented in the GUI 12 in the embodiment illustrated in FIG. 3. These are shown as a “View” control 56, an “Edit” control 58, and a “Source” control 60. Selection of the “Edit” control 56 allows a user to easily manipulate testing conditions through steps that are logically created through hierarchically-based drop-down menus.

The interface provides a plurality of user-selectable test actions provided through a drop-down menu or other selectable control. Specifically, the interface presents a plurality of available actions or functions that are available to test the functionality of the created web page or application. User selection of one or more these actions presents parameters and arguments associated with a particular action in a hierarchical format. In the example of FIG. 3, a first step of the test is to login, via a first drop-down menu 62 which presents a “Login” action. The Login action permits the user to login in this instance by presenting the name “miningTester1” to the user via a drop-down menu 64, associated with the Login action presented by the first drop-down menu 62 through location in a row occupied by the Login menu 62. In this way, a parameter associated with the test function “Login” is presented in manner that permits the user to intuitively interact with the test program.

The second step is to go to a particular website or web-based application to be tested via a “Go to” action 66. The website or web-based application may reside within a particular corporate intranet (here it is the “Live” application on the “CDA-Mining” site), or elsewhere. As with the Login menus, a series of horizontally associated parameters and arguments are presented to the user to permit the desired action to be performed. Preferably, the parameters and arguments associated with an action are provided as a series of user-selectable drop-down items, presented in such a way as to create sentence structure or quasi-structure. The third step in the example is to perform a “Verify” action 68 to verify that particular text is present on the presented site. As with the other test actions performed by the system, the parameters and arguments associated with this action are presented in as user-selectable drop-down items. In the illustrated example, the test checks that the text “ukyviuutwitucityi” is present on the relevant web page. Steps can be added or deleted using the plus and minus buttons to the left of each step.

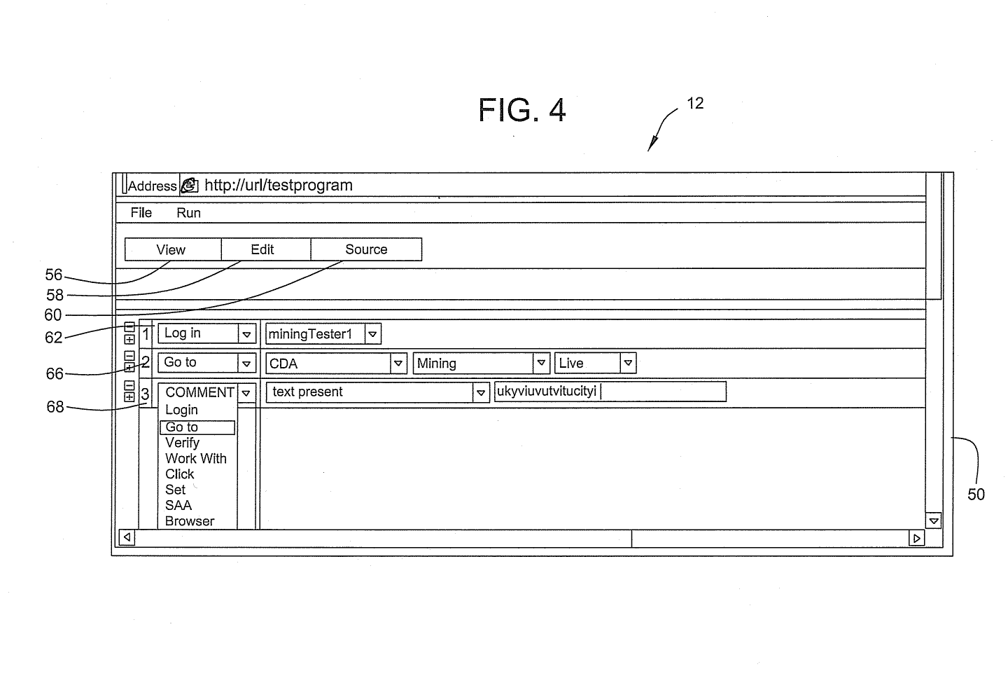

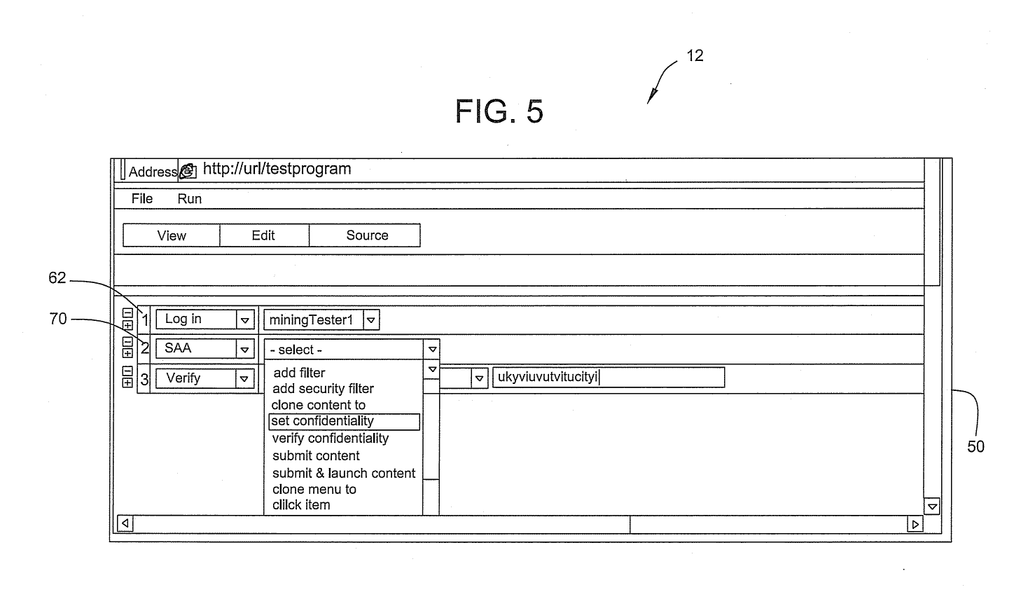

In greater detail, and with reference to FIG. 4, the first drop-down menu 62 allows for a selection of actions to be tested (e.g., “Login”, “Go to”, “Verify”, “Work with”, “Click,” “Set,” “SAA,” and “Browser”). Additionally, a “Comment” action is provided to allow a user to embed notes that are not performed during execution of the script. Depending on the action selected, a second drop-down menu is presented alongside the selected action. The choices in the second drop-down menu are acceptable arguments for the selected action. Shown with greater detail in FIG. 5, the available arguments for a second action 70, “SAA”, selected from the drop-down menu 68, include “add filter”, “add security filter”, etc. Additional drop-down menus or text boxes can similarly be presented based on the hierarchy of selected actions and arguments, so that options to select a second, third or fourth argument might appear alongside the action. The determination of the hierarchy and the available options in the drop-down menus are preferably made by administrators through standard GUI programming languages, such as JavaScript.

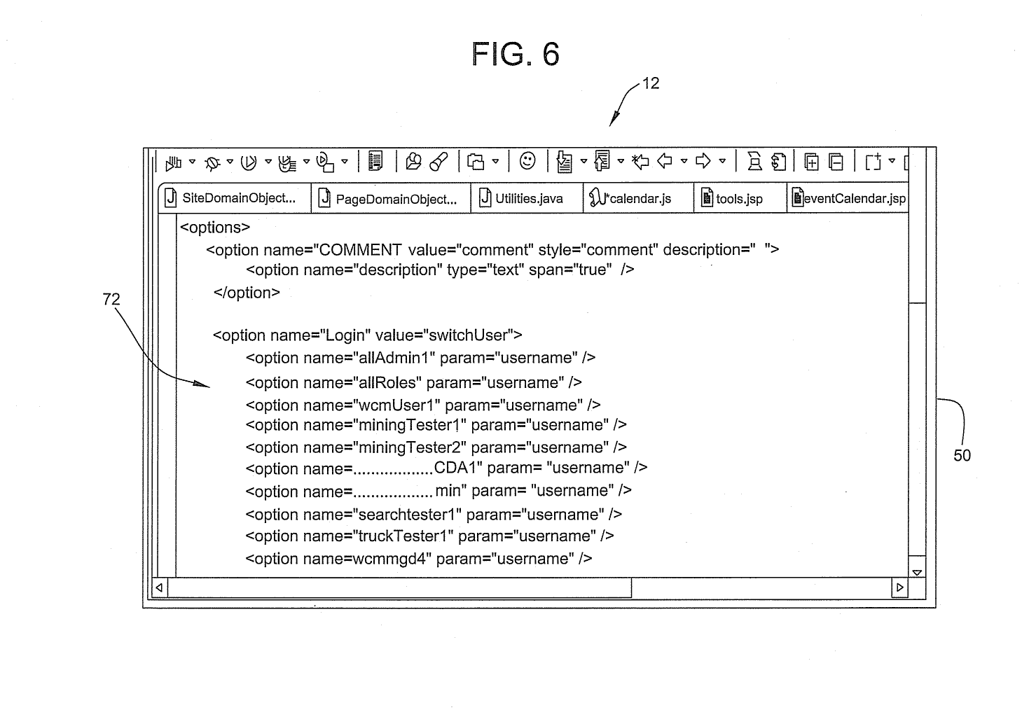

An exemplary JavaScript implementation for the GUI hierarchy of FIGS. 3-5 is shown in FIG. 6. The portion of a JavaScript file 72 displayed in FIG. 6 illustrates the first two actions available in the drop-down menu of FIG. 5. Selecting the first action, “COMMENT” would result in presentation of a single argument, which is a text box for a comment description. Selecting the second action, “Login”, would result in an argument of another drop-down menu containing options for many different login types (“allAdmin1”, “allRoles,”, “wcmUser1”, etc.)

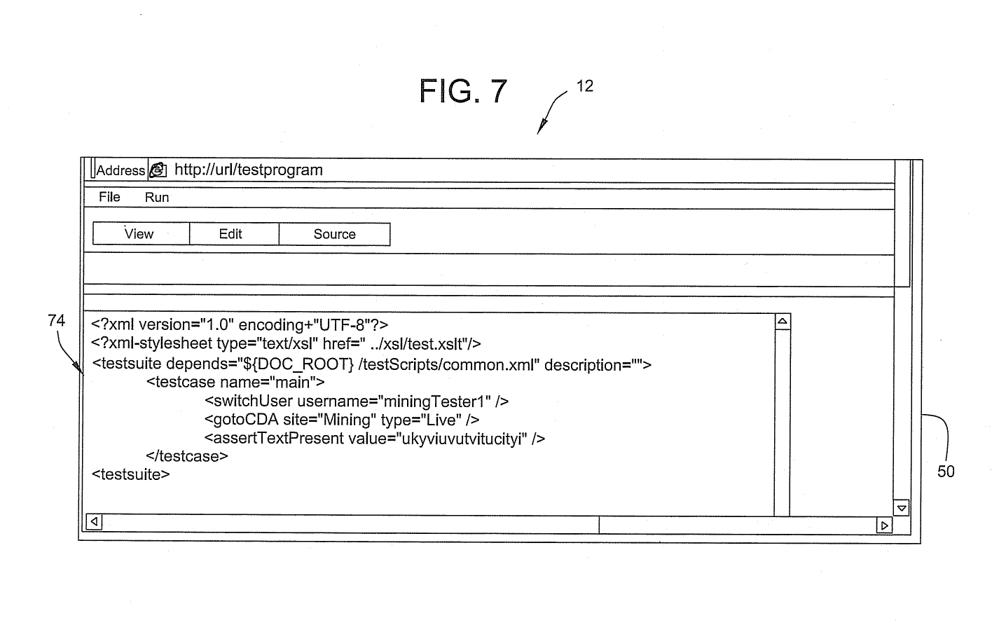

Turning to FIG. 7, an exemplary text-based test script 74 is shown. The script is displayed when the “Source” button is selected, and is preferably generated automatically from user-entered steps in the “Edit” screen of FIGS. 3-5. In particular, the script of FIG. 7 corresponds to the editing steps of FIG. 3, so that the editing of steps through the hierarchically-based drop down menus results in the automatic creation of the script. The script can contain variables that are later given particular values, such as at time of simulating the execution. These variables can be assigned different values depending on, for example, the particular environment selected for simulation. For example, a script may contain a variable for a URL that is assigned one value when executed in one environment, and a second value when executed in a second environment. This is an advantage achieved partially through the use of text-based scripts.

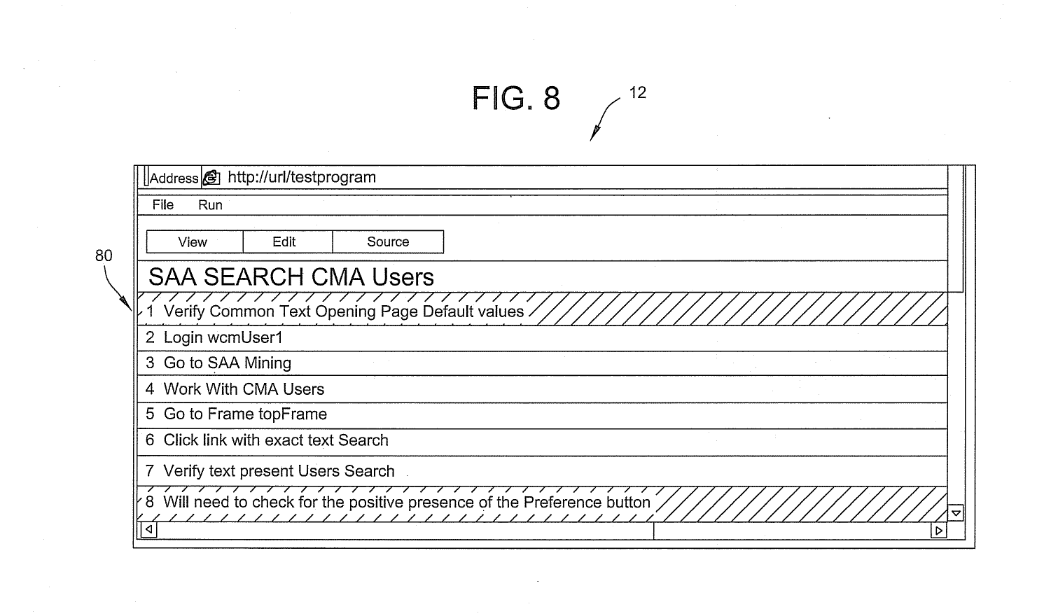

FIG. 8 displays an exemplary set of testing steps 80 presented by the GUI 12, corresponding to the “View” button of FIG. 3. These steps are preferably displayed during a test/debug session during which a script executes. A text-based script, such as one generated from the hierarchically-based drop down menus of FIG. 3, is used to generate the steps. In particular, the selected environment and other administrator-controlled information are used to translate the text-based script into particular user-level steps to be simulated during a test.

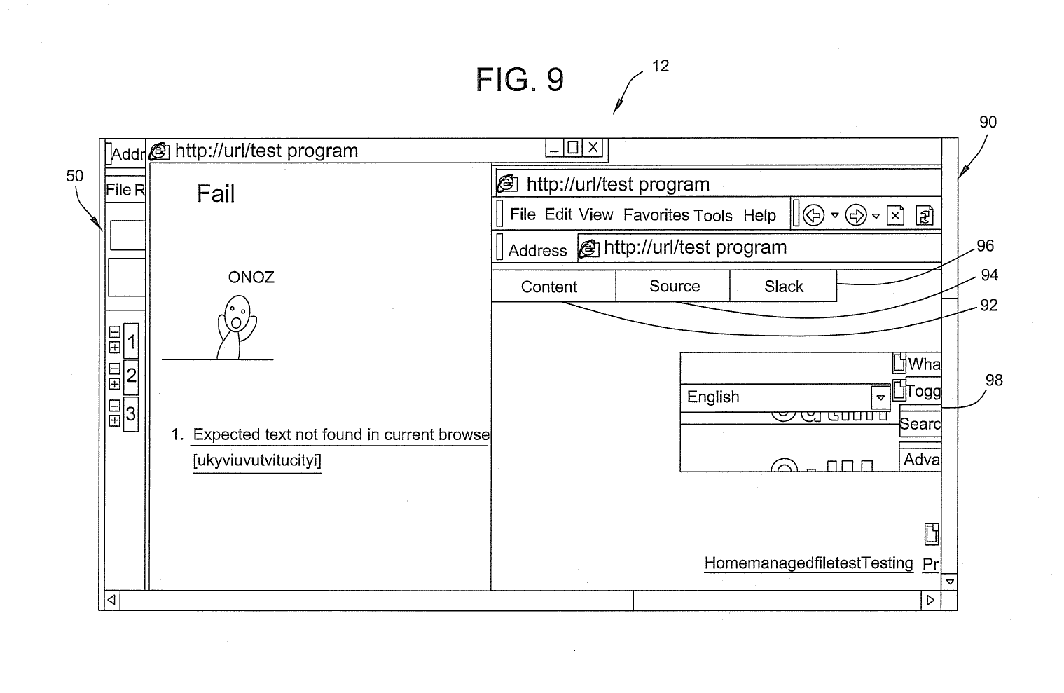

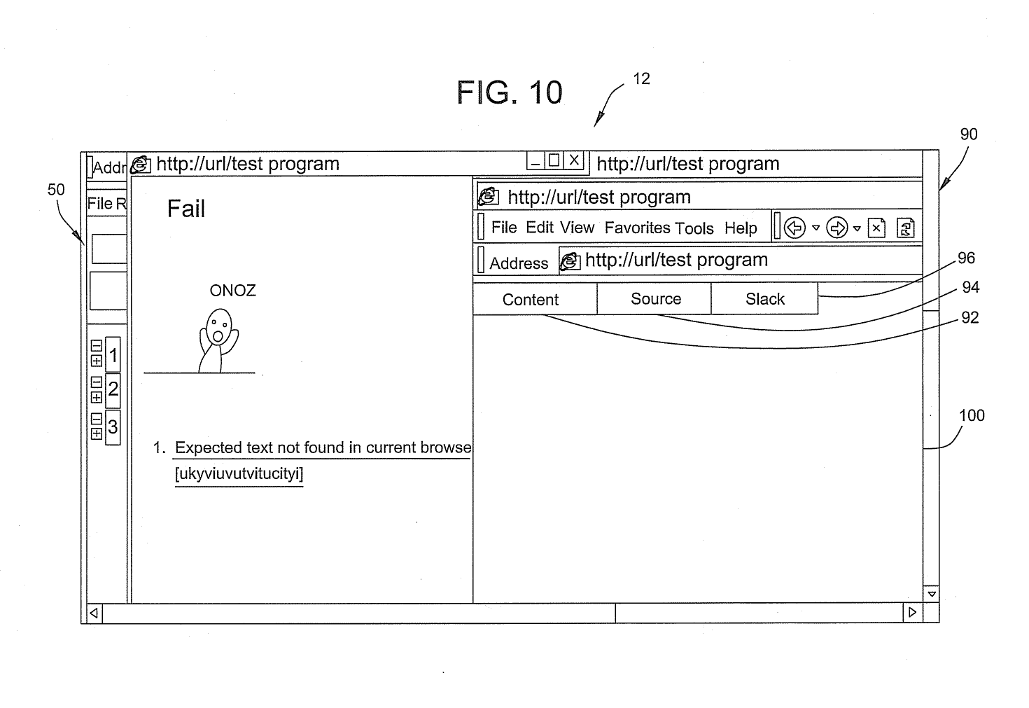

An exemplary execution of a test script is now described with respect to FIGS. 9 and 10. When an execution of a test script begins, several windows may be available to the user through one or more GUIs. For example, the GUI of FIGS. 3-8, may be available in window 50 to allow the user to follow the script steps during execution. Preferably, the user may use this GUI to selectively monitor the execution's progress by, for example, selecting particular break points.

Another window 90 is used to show the simulation itself. This window preferably contains several viewing options, including a “Content” screen as selected by a control 92, a “Source” screen as selected by a control 94, and a “Stack” screen as selected by a control 96. The “content” screen is used to display a web page 98 as it would be seen by an end user manually performing the steps of the test script. With reference to FIG. 3, the Content screen of FIG. 9 shows that the first two steps have occurred (i.e., the user has logged in as miningTester1 and gone to the CDA/Mining/Live web page). When the third step is attempted (verifying that the text “ukyviuvutvitucityi” is present on the page, the test fails. This failure is preferably captured in a different status window (“Expected text not found in current browser”).

The “Source” screen of the simulation window can be selected to see the underlying source code of the displayed content, such as an HTML file.

The “Stack” screen 100 is shown in FIG. 10, and can be used to display lower level actions that were performed during the test execution. For example, the stack of FIG. 10 shows low level steps that were performed leading up to the failure to find a text string on the web page.

### INDUSTRIAL APPLICABILITY

The industrial applicability of the web-based application testing system and method described herein will be readily appreciated from the foregoing discussion. The disclosed system and method may be particularly suitable for use in large organizations in which it is often difficult to implement testing methodologies across diverse business units. However, the disclosed system and method may be used in any environment in which web-based application testing is desirable.

The present disclosure therefore allows testing of web-based functionality in an environment that is easily scalable across large organizations. The testing is scalable horizontally, even though the web applications of one group may be written in different script from web applications in another group. Also, the testing system does not require interoperability among scripts of different groups, which historically have been either object code or fairly low-level source code (e.g., C). In addition, global operations, such as global search/replace operations may be performed across scripts. The testing system and method also permit vertical scalability as several different environments in which testing is performed, such as Quality Assurance, testing, or the like, do not require changed variables or other modifications from one environment to next. This is often the case with current testing methodologies due to differences in local URL references and the like.

Therefore, the present disclosure provides improved management of testing, particularly across large organizations. Test scripts may be more readily reused and shared. Writers of test scripts are also the same people who wrote the web application in the first instance. This reduces the potential for gaps in testing. The present disclosure thus provides a testing system that is easy for the test creator and operator, and allows for greater reusability and interoperability on an enterprise scale. This is particularly true in connection with large corporations that have many internal web sites, each possibly with own functionality.

It will be appreciated that the foregoing description provides examples of the disclosed system and technique. However, it is contemplated that other implementations of the disclosure may differ in detail from the foregoing examples. For example, the particular screen displays set forth in FIGS. 3 through 9 are shown for illustrative purposes only. The functionality and presentation of the various user-selectable test options may be presented in any number of ways, so long as a hierarchical relationship is maintained. All references to the disclosure or examples thereof are intended to reference the particular example being discussed at that point and are not intended to imply any limitation as to the scope of the disclosure more generally. Any language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method of testing the functionality of a web-based application comprising:
providing a graphical user interface via a web page, the graphical user interface containing hierarchically-based user-selectable options of performable testing steps;
receiving, via the web page, selected options from the graphical user interface;
converting the received options into a text-based test script; and
executing the text-based test script in a specified environment for the web-based application.

2. The method of claim 1 further comprising:
receiving a selection of the specified environment; and
automatically substituting portions of the text-based test script corresponding to the selected environment.

3. The method of claim 2 wherein the specified environment is a member of the group consisting of: a test environment; a development environment; and a quality assurance environment.

4. The method of claim 1 further comprising storing the text-based script in a repository of test scripts.

5. The method of claim 4 further comprising performing a global edit on a plurality of test scripts in the repository.

6. The method of claim 1 wherein each performable testing step in the graphical user interface comprises an action selected from a plurality of actions, and a set of acceptable arguments for the selected action.

7. The method of claim 6 wherein the plurality of actions and the set of acceptable arguments for the selected action are accessed from one or more text-based files during the providing of the graphical user interface.

8. The method of claim 1 wherein executing the text-based test script comprises:
attempting to perform a step from the text-based script in the specified environment; and
presenting an error message when the step cannot be performed.

9. The method of claim 1 wherein the graphical user interface further contains a user-selectable option to view the text-based test script.

10. A system for testing the functionality of a web-based application comprising:
a graphical user interface for specifying instances of conditions to be tested in a simulated execution of the web-based application;
a text-based test script generated from entries in the graphical user interface;
a user-selectable environment selection option for specifying one of a plurality of environments for which a simulated execution is to occur;
a pre-simulation engine for automatically conforming the text-based script to criteria for a specified environment; and
a simulation engine for simulating execution of the text-based test script on a specified environment.

11. The system of claim 10 further comprising:
a repository of text-based test scripts; and
means for editing a plurality of test scripts in the repository with a single editing command.

12. The system of claim 10 further comprising a debugging interface for displaying steps of simulated execution of the text-based test script.

13. The system of claim 12 wherein the debugging interface displays steps by highlighting specified instances of conditions in the graphical user interface.

14. The system of claim 13 wherein the debugging interface displays steps by highlighting lines in the text-based test script.

15. The system of claim 10 wherein the graphical user interface comprises:
a set of first user-selectable options for selecting from a plurality of actions a set of actions to be stimulatingly executed; and
a set of second user-selectable options for selecting an argument for each selected action in the set, each argument selected from a plurality of possible arguments for the corresponding action.

16. A graphical interface for presenting a user-definable testing environment of the functionality of a web-based application, the graphical user interface including a menu listing including:
a first user-selectable option of performable testing steps, the first user-selectable option specifying a test action to be performed and one or more test parameters that are displayed only when the first option is selected;
a second user-selectable option of performable testing steps that are different than the first user-selectable option, the second user-selectable option specifying a test action to be performed and one or more test parameters that are displayed only when the second option is selected; and
a third user-selectable execution for causing execution of a test for the web-based application based upon selection of the first and second user-selectable user options.

17. The graphical interface of claim 16 further comprising a user selection specifying an environment for execution of the web-based application.

18. The graphical interface of claim 17 wherein the specified environment is either a test environment, a development environment, or a quality assurance environment.
